(19) United States
(12) Patent Application Publication
(10) Pub. No.: US 2013/0258340 A1
(43) Pub. Date: Oct. 3, 2013

(54) TESTING APPARATUS AND TESTING METHOD FOR A TRAFFIC MONITORING DEVICE WITH A LASER SCANNER

(71) Applicant: JENOPTIK ROBOT GMBH, Monheim (DE)

(72) Inventors: Michael TRUMMER, Jena (DE); Michael LEHNING, Hildesheim (DE); Christoph GEBAUER, Koeln (DE)

(73) Assignee: JENOPTIK Robot GmbH, Monheim (DE)

(21) Appl. No.: 13/848,498

(22) Filed: Mar. 21, 2013

(30) Foreign Application Priority Data
Mar. 27, 2012 (DE) DE102012102651.3

(51) Int. Cl. G01B 11/26

(52) U.S. Cl. CPC G01B 11/26
USPC 356/401

(57) ABSTRACT

A testing apparatus and a testing method for a traffic monitoring device with a laser scanner. The testing apparatus has an adjusting plate which provides a receiving place for receiving a traffic monitoring device which is to be tested and a measuring board. A line pattern along an imaginary straight line extending at the height of the reference scanning plane is provided on the measuring board which has a matte black surface. Vertical lines and a diagonal line are arranged on the straight line, and the diagonal line forms an angle with the straight line, which angle is selected in such a way that laser pulses emitted by the laser scanner form at least three laser spots with a reference laser spot width and a reference laser spot length on the diagonal line.

### RELATED APPLICATIONS

The present application claims priority benefit of German Application No. DE 10 2012 102 651.3 filed on Mar. 27, 2013, the contents of which is incorporated by reference in its entirety.

### BACKGROUND OF THE INVENTION

The invention is directed to an apparatus and a method for testing and calibrating a traffic monitoring device (“TMD”) with a laser scanner.

The TMD can also additionally have a camera. The camera is already aligned at the factory, is fixedly connected to the laser scanner and is therefore aligned with respect to a laser scanner coordinate system.

Various characteristics and parameters of the TMD are to be tested and stored by the testing apparatus (hereinafter, “test criteria”) for use as evidence of the calibration condition, for use in assessing measurements, or to carry out a calibration.

The test criteria are intrinsic parameters of the laser scanner and/or of the camera and of the alignment of the camera with respect to the laser scanner, as the case may be.

A conventional laser scanner, the testing of which is assumed herein by way of example, has a laser diode as laser source and a polygon mirror as scanning device. However, the method and the apparatus are not limited to the testing of a laser scanner of this kind. They are also not limited to a laser scanner which emits a laser beam having a beam divergence that is greater than perpendicular to the scanning direction than in the scanning direction.

Compliance with the test criteria must be tested at regular intervals. A testing apparatus according to the invention and a testing method according to the invention can be used in an advantageous manner for this purpose.

For a TMD having a laser scanner for carrying out a measurement task and possibly a camera for documenting a measurement result, the following test criteria must be checked or calibrated:
1. testing of the scanning plane of the laser scanner respecting vertical angular position and height relative to the laser scanner coordinate system;
2. testing and calibration of the zero position of the scanning plane of the laser scanner perpendicular to the scanning plane;
3. testing of the conformality of the scan;
4. testing of beam characteristics of the laser beam;
5. testing of the exactness of the distance measurement;
6. testing of the transmitting power of the laser diode;
7. testing of the timing accuracy and synchronous running of the polygon mirror;
8. testing of different reflection characteristics;
9. testing of the alignment of the camera relative to the laser scanner and, therefore, to the laser scanner coordinate system.

A method and apparatus for testing the alignment of a laser scanner fastened to an object, particularly to a vehicle, is known from EP 1 355 128 B1.

The reference alignment of the laser scanner with respect to the vehicle is selected in such a way that the scanning plane extends horizontally and the zero position of the scanning plane (0° shot in the reference) extends in a driving direction and therefore parallel to the longitudinal axis of the vehicle.

The apparatus has at least one boundary wall which is fixedly arranged at the vehicle in an area of its scanning angle range that does not limit the functioning of the laser scanner, which is mounted according to specifications of the vehicle. Assuming a maximum relevant scanning region of 275° for unrestricted functioning of a laser scanner of this kind, there remains for a 360-degree scanner an angular region of 90° in which at least one boundary wall, or preferably two boundary walls, associated with the apparatus can be arranged so as to form a right angle with one another. The at least one boundary wall is formed in certain areas as a test surface which can be embodied in a variety of ways. The boundary wall and, therefore, the test surface, are aligned with a vehicle-specific coordinate system.

The test surface can be, e.g., a camera-specific CCD matrix by means of which the position of a scanning spot or laser spot formed when the scanning laser beam impinges on the test surface can be determined. In so doing, the camera and consequently the camera-specific CCD matrix are arranged at the boundary wall and, therefore, indirectly at the vehicle, such that the laser beam impinges along the rows of the CCD matrix when the scanning plane is correctly aligned.

Alternatively, it is suggested, for example, to use the receiving device specific to the laser scanner instead of a camera as a device for verifying the impingement of the laser beam and to provide the test surface as an emitting or reflecting line pattern. The line pattern comprises a plurality of test lines, at least two of which do not extend parallel to one another. They can be arranged, for example, in an N shape, M shape, V shape or W shape. In none of the examples cited above for the test pattern do the test lines intersect. The diameter of the laser spot which generates the laser beam on the test surface is small in proportion to the length of the lines and is only slightly greater than the width of the lines.

The position of the scanning plane can be coded by the relative arrangement of the test lines such that when the sensor is correctly aligned laser pulses reflected at the test lines are detected only at an expected time point or an expected angular position of the scanner, whereas reflected pulses are detected at erroneous times or erroneous angular positions in case of incorrect alignment. Paragraphs [0071] to [0077] of the specification herein, referring to FIG. 6, describe how the kind of deviation from a reference alignment can be deduced from the sequence of angular positions at which radiation is detected.

When the scanning plane is correctly aligned, there are fixed anticipated differences in the scanning angle (angular distances in the above-cited reference) swept by the laser beam between the reception of the respective laser beam which is possibly reflected at one of the test lines and which is emitted, e.g., by the transmitting device of the laser scanner.

An apparatus and a method making use of the disclosures of the above cited patent application EP 1 355 128 B1 is not sufficiently accurate for traffic monitoring devices with laser scanners which, by virtue of their application, emit laser pulses with a beam cross section having a vertical divergence that is many times greater than the horizontal divergence. Thus a laser spot occurring on the test surface has a vertical dimension (length) perpendicular to the scanning direction that is many times greater than its horizontal dimension (width) so that an unambiguous assignment of the respective receive signals to only one angular position, respectively, is impossible if this is not caused by reflection at a perpendicularly aligned line.

Further, in a traffic monitoring device having a laser scanner and a camera, an apparatus of the kind mentioned above is also not suitable for testing characteristics of the camera or for testing the alignment of a camera and laser scanner relative to one another. Moreover, this apparatus is not suitable for checking measurement results by other means (redundant testing).

### SUMMARY OF THE INVENTION

It is an object of the invention to provide a testing method and a testing apparatus suited thereto such that a traffic monitoring device with a laser scanner emitting a laser beam, whose divergence perpendicular to the scanning direction is greater than its divergence in the scanning direction, can be tested in a highly accurate manner with respect to the position of the scanning plane.

The testing method and testing apparatus should be suitable for testing the position of the scanning plane redundantly by other means. Further, the testing method and testing apparatus should be suitable for checking the alignment of a camera with respect to the laser scanner, which camera is additionally associated with a traffic monitoring device, and to test other test criteria of the laser scanner and camera. The testing apparatus should advantageously be compact, transportable and protected against unauthorized tampering.

The above-stated object is met by a testing apparatus having an adjusting plate, which provides a receiving place for receiving in a defined manner a device, which is to be tested and which has a laser scanner, and having a measuring board arranged at a fixed distance from the adjusting plate. The measuring board has a line pattern along an imaginary straight line with a plurality of vertical lines running perpendicular to the straight line and with a diagonal line. The adjusting plate and the measuring board can be aligned relative to one another in such a way that the straight line lies in a reference scanning plane of the laser scanner. The diagonal line intersects the straight line on a perpendicular center line of the measuring board and forms an angle with the straight line. The angle is selected in such a way that laser pulses emitted by the laser scanner form at least three laser spots with a reference laser spot width and a reference laser spot length on the diagonal.

The angle is advantageously given by α=arc sign (S_{L}/2)/(D_{L}/2), where S_{L} is the reference laser spot length and D_{L} is the length of the diagonal line. In this regard, D_{L} is as long as possible. Under this condition, the rise and the fall of a quality curve formed from the receive signals of the laser pulses reflected by the diagonal line achieve the greatest width and, therefore, the highest sensitivity for deviations in the position of the laser spots.

It is further advantageous when the vertical lines are narrow vertical lines with a line width equal to the reference laser spot width and/or wide vertical lines with a line width equal to the multiple of the reference laser spot width and the line length of the vertical lines is equal to the reference laser spot length so that a deviation of the scanning plane from the reference scanning plane and a deviation of a zero position of the scanning plane from a reference zero position can be determined.

An attenuation disk is provided between the adjusting plate and the measuring board, and the measuring board has a matte black surface of a determined reflectivity. This reflectivity is high enough to ensure that in conjunction with the attenuation disk a reflection of the laser pulses of a laser beam coming from the laser scanner back into the laser scanner is still just sufficient to form a distance value from the generated receive signal.

The measuring board has a rectangular shape, wherein a measuring mark is provided in the center at the four edges. Further, the testing apparatus includes a test laser which is mounted on the adjusting plate so as to be aligned therewith. The test laser is suitable for emitting a test laser beam with a cross-shaped beam cross section by which the measuring board and adjusting plate can be aligned relative to one another.

The measuring board has lower projection surfaces at the level of the line pattern. Further, a test camera is associated with the testing apparatus. The test camera is mounted on the adjusting plate so as to be aligned therewith such that the lower projection surfaces lie in the object plane of the test camera so that laser spots imaged therein are sharply imaged by the test camera.

The measuring board has two upper projection surfaces above the line pattern. Further, two deflecting mirrors and a test camera are associated with the testing apparatus. The test camera is mounted on the adjusting plate so as to be aligned therewith such that the upper projection surfaces lie in the object plane of the test camera. The two deflecting mirrors are so arranged that impinging laser pulses impinge on one of the upper projection surfaces in each instance.

In order to realize a plurality of measuring distances, the measuring board has at least one mirror surface, and at least one individual mirror is associated with the testing apparatus. The at least one mirror surface and the at least one individual mirror are arranged with respect to one another and with respect to the adjusting plate such that a laser pulse impinges on the measuring board so as to be repeatedly folded to realize at least one measuring distance corresponding to a multiple of the distance between the adjusting plate and measuring board.

In order to align a camera possibly associated with the device, the measuring board is advantageously surrounded by a white frame which is imaged via the test camera.

The above-stated object is also met by a testing method in which a scanner-specific coordinate system of a TMD has a laser scanner and a measuring board has a line pattern along an imaginary straight line with a plurality of vertical lines running perpendicular to the straight line and a diagonal line which intersects the straight line on a perpendicular center line of the measuring board, wherein it forms an angle with the straight line, which angle is selected in such a way that at least three laser spots of laser pulses emitted by the laser scanner, which three laser spots have a reference laser spot width and a reference laser spot length, impinge on the diagonal line, which scanner-specific coordinate system of a TMD and measuring board are so aligned with respect to one another that the straight line lies in a reference scanning plane of the laser scanner.

The laser scanner emits a laser beam with a plurality of laser pulses over a scanning angle region, which laser pulses impinge on the measuring board, where each of them forms one of the laser spots. When impinging on the vertically extending vertical lines and the diagonal line, the laser pulses are reflected into a receiver of the laser scanner, where there are generated receive signals having a quality and an amplitude.

An actual quality curve over the scanning angle (Φ) is formed from the values of the quality, i.e., the amplitude, of the receive signals and is compared with a known reference quality curve. The position of the actual scanning plane compared to the reference scanning plane, inter alia, can be deduced in this way.

### BRIEF DESCRIPTION OF THE DRAWINGS

The invention will be described more fully in the following with reference to embodiment examples and drawings. In the drawings:

FIG. 1 is a perspective view of a testing apparatus according to a first embodiment example;

FIG. 2 shows a measuring board according to the first embodiment example;

FIGS. 3a-3c illustrates the measuring board according to FIG. 2 with laser spots of a laser pulse train imaged thereon and associated quality curves of the receive signal;

FIGS. 4a-4b show measuring boards according to further embodiment examples.

### DESCRIPTION OF THE EMBODIMENTS

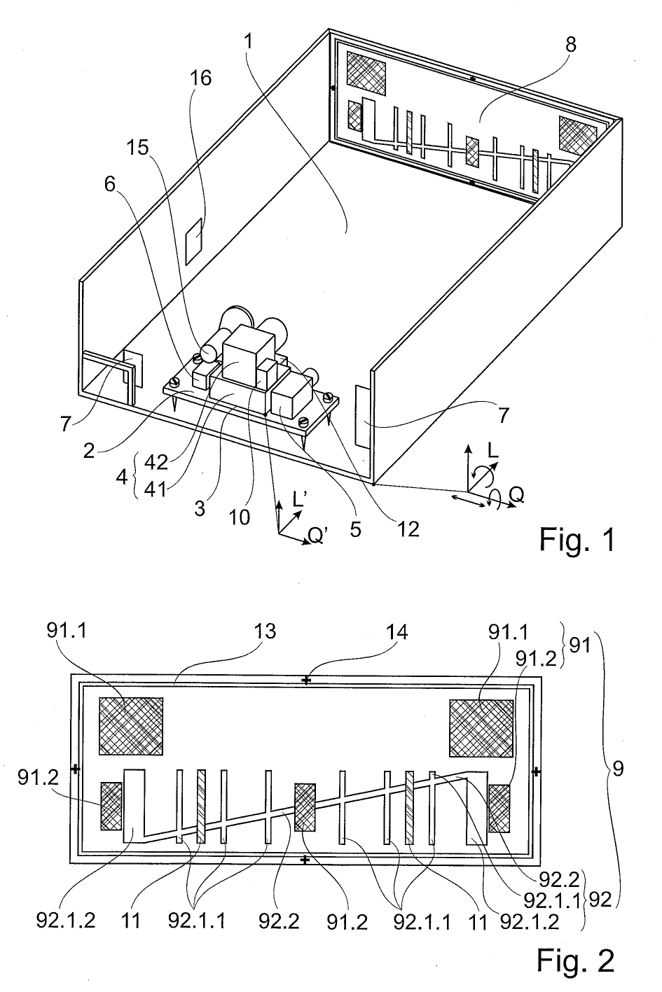

A first embodiment example for a testing apparatus is shown in FIG. 1.

The testing apparatus substantially comprises a base plate 1 which can be the rigid base of a housing for the testing apparatus, an adjusting plate 2 with a receiving place 3 for a traffic monitoring device (TMD) 4 which is to be tested and which has a laser scanner 41 and a camera 42, a test camera 5, a test laser 6, a plurality of individual mirrors 7, an attenuation disk 12, a measuring board 8 and a storage 10.

The adjusting plate 2 is manually tiltable, within tolerance limits, relative to the base plate 1 and a Cartesian coordinate system specific to the base plate 1 around the longitudinal axis L and transverse axis Q thereof.

The measuring board 8 is exchangeably mounted on the base plate 1 and is manually displaceable in a direction of the transverse axis Q relative to the latter and relative to the coordinate system which is fixed with respect to the base plate. These three degrees of freedom are sufficient for aligning the measuring board 8 and the adjusting plate 2 relative to one another.

A receiving place 3, on which a TMD 4 to be tested can be placed in a defined manner with respect to the adjusting plate 2, is secured to, the adjusting plate 2 by guide pins, stops, or the like. A scanner-specific coordinate system of the laser scanner 41 is aligned relative to the adjusting plate 2 by the defined placement of the TMD 4. After the measuring board 8 and adjusting plate 2 are aligned with respect to one another, the measuring board 8 is aligned with respect to the scanner-specific coordinate system. This is the prerequisite for checking test criteria of the laser scanner 41 and camera 42 connected therewith by means of the testing apparatus with the aid of the measuring board 8.

The adjusting plate 2 is arranged as close as possible to one end of the base plate 1, and the measuring board 8 is arranged as close as possible to another end of the base plate 1 so that there is a greatest possible distance therebetween in direction of the longitudinal axis L. This distance basically determines the optical distance between the TMD 4 and components such as measuring surfaces 9 which are provided on the measuring board 8. The optical distance is multiplied for certain measuring purposes by the individual mirrors 7 and mirror surfaces 11 provided on the measuring board 8 so that a plurality of measuring distances of defined length can be realized by folding the laser beam.

The test camera 5 is arranged on the adjusting plate 2 and aligned with respect to the receiving place 3. With the test camera 5, for example, the distance and angular alignment of the measuring board 8 with respect to the receiving place 3 can be checked. Its camera objective images the entire measuring board 8.

The test laser 6 which emits a test laser beam with a cross-shaped beam cross section is provided for redundant monitoring of the alignment of the measuring board 8. The test laser 6 is aligned relative to the receiving place 3. When the measuring board 8 is correctly aligned with respect to the receiving place 3, the two arms of the cross-shaped test laser beam impinge diagonally on the measuring board 8 and intersect the four measuring marks 14 which are each provided in the center at the edges of the measuring board.

The measuring board 8 comprises a black plate which has various components, to be described below, and which allows the test criteria listed under items 1 to 9 for the laser scanner 41 and the camera 42 and the relative alignment thereof with respect to one another to be determined. The presence of some components on the measuring board 8 is obligatory, while others are provided only advantageously. The components of the measuring board 8 shown in FIG. 2 include a plurality of measuring surfaces 9, also different measuring surface 9, two mirror surfaces 11, four measuring marks 14 and a frame 13.

In conjunction with the attenuation disk 12, which is positioned directly in front of the laser scanner 41 arranged on the receiving place 3, the matte black surface of the measuring board 8 ensures a minimal reflection of the laser pulses of a laser beam coming from the laser scanner 41 back into the laser scanner 41 such that a distance value can still just be formed from the generated receive signal.

Depending on their function, the measuring surfaces 9 are arranged on the measuring board 8 with different materials or paints, in different shapes, sizes and positions. The measuring surfaces 9 of the measuring board 8 shown in FIG. 2 include projection surfaces 91, distinguished as upper projection surfaces 91.1 and lower projection surfaces 91.2, and reflection surfaces 92, the lower projection surfaces 91.2 being arranged on the level of the scanning plane.

The lower projection surfaces 91.2 are matte white and have a size that is greater than the cross section of an impinging laser spot so as to image the latter in an optimal manner so that an easily evaluated image thereof can be recorded by the test camera 5.

The upper projection surfaces 91.1 serve to image laser spots generated by the laser pulses which delimit the scanning angle region, i.e., the first and last laser pulses of the laser pulse train of a scan. Depending on the length of the testing apparatus in direction of the longitudinal axis L, the width of the testing apparatus, in direction of the transverse axis Q, limits the angular region in which the emitted laser pulses impinge on the measuring board 8. When this angular region, e.g., 20°, is only part of a scanning angle range of 70°, for example, then only the center laser pulses are directed to the measuring board 8 on a direct path. This is sufficient for testing many test parameters as well as the position of the scanning plane. However, in order also to test edge laser pulses, the latter are deflected indirectly by deflecting mirrors 16 onto the measuring board 8 and onto the upper projection surfaces 91.1 thereof, where they can be evaluated in the same way as the center laser pulses via the lower projection surfaces 91.2, which will be explained later. In this way, the testing apparatus can be limited to a compact width irrespective of the scanning angle region without having to forfeit the option of evaluating the edge laser pulses.

The reflection surfaces 92 are made from a retroreflective material which, as far as possible, reflects the entire incident energy of the laser beam coming from the laser scanner 41 back to the laser scanner 41 and collectively form a line pattern along an imaginary straight line G.

The reflection surfaces 92 include a plurality of vertical lines 92.1 which are perpendicular to the straight line G and a diagonal line 92.2 which intersects the straight line G at an angle α. The vertical lines 92.1 and the diagonal line 92.2 are used for checking the correct height and a horizontal alignment of the scanning plane with respect to a scanner-specific coordinate system.

In principle, a plurality of diagonal lines 92.2 could also be provided, or the one diagonal line 92.2 could not intersect the straight line G on the center line M of the measuring board 8; but this would result in an inferior construction of the measuring board 8 as it relates to the testing method. It is essential that the diagonal line 92.2, depending on the angular distances between two consecutive laser pulses and on the reference laser spot length S_{L}, forms an angle α with the straight line G such that at least three laser spots are imaged on the diagonal line 92.2. There need not be a diagonal in the mathematical sense in the line pattern.

To implement the testing method using the measuring board 8, it is of advantage for the spatial resolution in scanning direction when the rise and fall of the portion of a quality curve formed from the receive signals of the laser pulses reflected by the diagonal line 92.2 is relatively wide. The greatest width, and therefore the highest sensitivity for deviations of the position of the laser spots, is obtained when the diagonal satisfies the following condition:

α=arc sin(S_{L}/2)/(D_{L}/2),

where S_{L} is the reference laser spot length, D_{L} is the length of the diagonal line 92.2, α is the angle formed by the diagonal line 92.2 with the imaginary straight line G, and D_{L} is as long as possible.

There are wide vertical lines 92.1.2 and narrow vertical lines 92.1.1. The narrow vertical lines 92.1.1 and the one diagonal line 92.2 are the only obligatory components that the measuring board 8 must have. In this regard, it is essential that the narrow lines 92.1.1 are dimensioned so as to be equal in width to the reference laser spot width S_{B} of a laser spot so that a laser spot with a reference laser spot width S_{B} impinging centrally on a narrow vertical line 92.1.1 is completely reflected. Wider laser spots are damped in accordance with their width deviation.

The diagonal line 92.2 runs through the center of the line pattern which divides its length in half. It advantageously intersects a plurality of narrow vertical lines 92.1.1.

The reflection surfaces 92 also include wide vertical lines 92.1.2. The same applies for them as for the narrow vertical lines 92.1.1 in a corresponding sense, but the width of the wide vertical lines 92.1.2 corresponds to an integral multiple of the reference laser spot width S_{B}. The distance between the edges of the vertical lines 92.1 likewise corresponds to an integral multiple of the reference laser spot width S_{B}. The height of the vertical lines is greater than or equal to the reference laser spot length S_{L}.

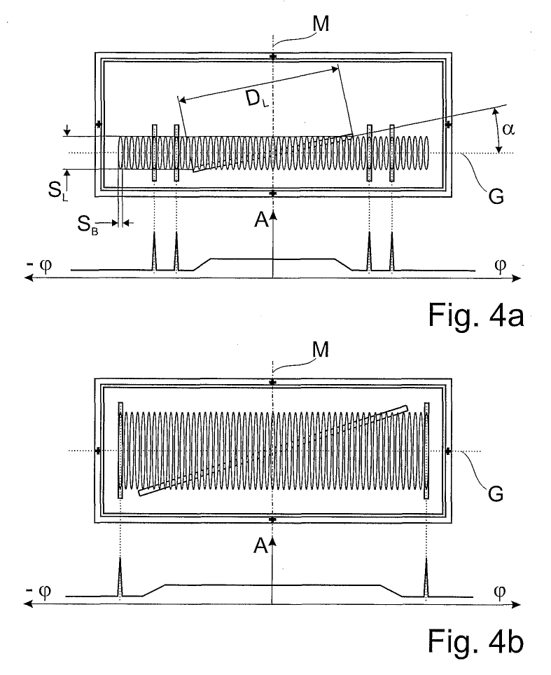

FIGS. 4a-4b show further embodiment examples for the measuring board 8 and the respective associated reference quality curves.

The testing apparatus is accommodated in its entirety in a closed housing whose bottom plate forms the base plate 1. The housing needs only two openings: one for inserting a TMD 4 into the testing apparatus or removing it therefrom and for manually adjusting the adjusting plate 2, and the other for inserting, aligning and visually observing the measuring board 8. The flaps can be secured after closing in order to prevent unauthorized access during testing.

At least one illumination device 15 is provided in the housing. The illumination device 15 is used for lighting for test steps in which recordings of the measuring board 8, or of sections of the measuring board 8, are made by means of the test camera 5 or the camera 42 of the TMD 4. The storage 10 is provided at the housing. For example, this storage 10 can be an outwardly accessible USB stick to which a computer can be connected.

The testing method comprises individual method steps which are fully automated. The control is carried out via the computer.

The method steps include test steps in which a respective test criterion is checked in order to save its actual condition to the storage 10 for documentation or for taking into account subsequently for measurements with the TMD 4 or in order to service the TMD 4 outside of the testing apparatus when the deviation of the actual condition from the reference condition is out of tolerance.

The testing method can also include calibrating steps in which, after testing a test criterion and determining an actual condition deviating from a reference condition, the test criterion is calibrated to the reference condition.

It is compulsory that the testing method includes the method step of testing the alignment of the scanning plane of the laser scanner 41.

Optionally, the testing method can advantageously include a redundant testing of the alignment of the scanning plane using other means and a correspondingly different method step as well as the testing or calibration of the other test criteria.

The measuring board 8 is required in all testing and calibrating steps and its correct alignment is therefore particularly critical.

Prior to carrying out the testing method, the testing apparatus must be checked for correct setup and adjusted in case of deviations in order to obtain reliable results. This is done using the test camera 5.

The distance between this test camera 5 and the measuring board 8, and the alignment of the measuring board 8 with respect to the adjusting plate 2, is determined with the aid of the white frame 13 around the measuring board 8. To obtain a precise result, it is necessary that the test camera 5 be calibrated. In so doing, parameters such as exact focal length or distortion parameters of the camera objective are determined and stored in the storage 10. These parameters then enter into the determination of the geometric quantities of the testing apparatus.

Another option for checking whether or not the testing apparatus corresponds to requirements is realized by means of a test laser 6 which is aligned with the receiving place 3. The test laser 6 emits a test laser beam with a cross-shaped beam cross section. When the measuring board 8 is correctly aligned with respect to the receiving place 3, the arms of the cross lie on the four measuring marks 14 of the measuring board 8. If the measuring board 8 rotates in space or the distance of the measuring board 8 deviates from the reference value, the arms of the cross and the measuring marks 14 do not coincide. In this way, it is possible to visually check the correct setup of the testing apparatus.

To carry out the testing method, the following method steps must be executed consecutively:
1. defined insertion of the TMD 4 into the testing apparatus on the receiving place 3;
2. connection of the computer and initiation of the test program;
3. alignment of the measuring board 8 by means of the test laser 6 and by visual inspection;
4. closing of the housing of the testing apparatus;
5. recording of pictures with the camera 42 and test camera 5;
6. consecutive testing of individual test criteria (test steps);
7. evaluation of the test results;
8.1 conclusion of the testing process in case all values lie within the acceptance tolerances; or
8.2 recalibration of calibratable test criteria in case the deviation of the test results falls outside the acceptance tolerances but within the test tolerances;
8.3 repeating of the testing of individual test criteria for which the measurement results fall outside the test tolerances, and termination when deviation is confirmed;
9. preparation of a test log.

The different test steps will be described more fully in the following.

### Testing of Test Criterion 1—Vertical Angular Position and Height of the Scanning Plane of the Laser Scanner 41

As has been already explained, the reflection surfaces 92 are used for checking the correct height and a horizontal alignment of the scanning plane, i.e., the vertical angular position of the scanning plane should equal zero, with respect to a scanner-specific coordinate system. In order to test this test criterion, the measuring board 8 is scanned by the laser beam of the laser scanner 41 in the form of laser pulses with a known pulse frequency and a known scanning speed within a known scanning angle region.

Based on the known pulse frequency, the known scanning speed and the known scanning angle region, the quantity of laser pulses which are emitted per scan (laser pulse train of a scan) is known.

In case of conformality of the scan and synchronous running of the polygon mirror performing the laser beam scan, exactly one scanning angle φ can be assigned to each laser pulse of a laser pulse train within the scanning angle region and, therefore, to a reference impingement point on the measuring board 8. In other words, the reference impingement points for a correctly calibrated laser scanner are known and a determined laser pulse can be assigned to them.

When the divergence of the laser beam is known and an optical distance between the laser scanner 41 emitting the laser beam and the impingement point are known, the laser spots occurring at the point of impingement have a reference laser spot size with a reference laser spot width S_{B} in scanning direction and a reference laser spot length S_{L} perpendicular thereto, wherein the scanning direction falls on the straight line G.

For the description of this method step and of the method steps to be described in the following, it will be assumed that a laser beam of the laser scanner 42 has only a small divergence in scanning direction compared to the divergence perpendicular to the scanning direction. The small divergence in scanning direction and resulting small reference laser spot width S_{B} leads to a high spatial resolution of the measured values, while the large divergence perpendicular to the scanning direction ensures, specifically in traffic metrology, that in measurements with the laser scanner 41 suitable reflecting surfaces, which may be located at different height for different vehicles, are measured.

During a scan, the laser pulses of a laser pulse train alternately impinge on the measuring surfaces 9 and the black surface of the measuring board 8 and generate a laser spot at the point of impingement. Depending on the pulse frequency and the scanning speed, certain laser spots must lie on the reflection surfaces 92. The laser pulses impinging on the measuring board 8 are reflected back into the laser scanner 41 and cause a receive signal therein.

The quality of the receive signals, which is expressed in a defined amplitude A of the receive signal, differs as a function of reflection properties of the measuring board 8 at the point of impingement. The quality of the receive signals caused by the reflected and received laser pulses is used for evaluating the individual laser spots, and an actual quality curve for the amplitude A over scanning angle φ is formed therefrom.

The quality of the receive signal of a laser pulse which impinges entirely on the black surface is just high enough that a distance value can be still be formed, i.e., its amplitude A lies just above the sensitivity limit of the detector of the laser scanner 41 that receives the laser pulse.

The quality of the laser pulse that is completely reflected back by a reflection surface 92 is taken as maximum. The detector is selected in such a way that the sensitivity limit thereof lies just above the maximum amplitude A, i.e., this maximum amplitude A lies just below the saturation limit of the detector.

Laser pulses which impinge on the projection surfaces 91 form a laser spot there that is visually rendered in an optimal manner for purposes of evaluation in the camera image. The reflectivity of the projection surfaces 91 is higher than that of the black surface of the measuring board 8 but appreciably lower than that of the reflection surfaces 92.

The quality of the receive signals is tested and it can be deduced therefrom whether or not, for one, the correct laser spots impinge on the reflection surfaces 92 and, for another, the obtained quality corresponds to the reference value in order to determine whether or not the laser spots lie entirely on one of the reflection surfaces 92.

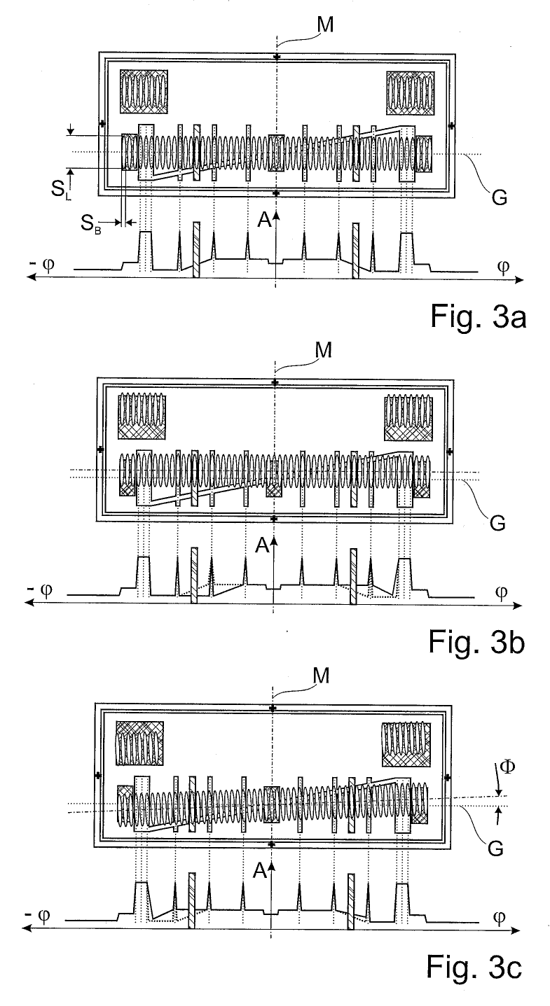

FIGS. 3a to 3c show a measuring board 8 on which at least the center laser spots and the edge laser spots of a scan are imaged and a respective actual quality curve associated therewith.

In the diagram in FIG. 3a, the scan was generated by a laser scanner 41 in correctly aligned scanning plane at a reference height along an imaginary straight line G. Accordingly, the actual quality curve corresponds to a reference quality curve.

During the scanning of the scanning angle region, starting from the left-hand side, the laser spot covers the diagonal line 92.2 first increasingly, then steadily, then decreasingly, ignoring the effect on the mean wide vertical lines 92.1.2. In case of a correct zero position and height position of the laser beam, a quality steadily increasing (rising edge) to a maximum value and a quality steadily decreasing (falling edge) from this maximum value result for the receive signals of the laser pulses which do not impinge on the vertical lines 92.1, where the maximum value is less than the quality of the receive signal of a laser pulse impinging completely on a vertical line 92.1. The shape of the quality curve is advantageously symmetrical on either side of the center line M thereof.

In the diagram in FIG. 3b, the scanning plane is too high, which may be caused by a tilting of the scanning plane around the transverse axis Q′ of the scanner-specific coordinate system. The actual quality curve that is formed shows that the position of the rising edge and falling edge described with reference to FIG. 2a has changed compared to the reference quality curve and is no longer symmetrical around the center line M. The measure of displacement of the edges is a yardstick for the deviation of the height of the scanning plane from a reference height.

A displacement toward the right-hand side indicates a height greater than the reference height. A shift toward the left-hand side correspondingly indicates a height of the scanning plane than is less than the reference height.

A deviation of the scanning plane from the horizontal as is shown in FIG. 3c takes place as a result of a tilting around the longitudinal axis L′ of the scanner-specific coordinate system and leads to an actual quality curve in which the aforementioned edges are compressed or elongated compared to the reference quality curve and are accordingly changed with respect to the rising slope.

The position of the scanning plane can be tested redundantly through the position of the impingement points of laser spots on three lower projection surfaces 91.2 (see FIGS. 3a-3c) of the same size which are provided at one height, which is explained in connection with the description of the testing and calibration of test criterion 2.

### Testing and Calibration of Test Criterion 2—Zero Position of the Scanning Plane Perpendicular to the Scanning Plane

The three lower projection surfaces 91.2 (see FIGS. 3a-3c) of identical size which are provided at one height are used for checking and calibrating the correct zero position of the scanning plane. Their width is greater than the reference laser spot width S_{B}, while their length is greater than the reference laser spot length. Both the length and the width are selected in such a way that with knowledge of a maximum deviation of the position of the laser spots within a permissible tolerance limit the spots are still imaged completely on the lower projection surfaces 91.2.

The laser scanner 41 is now so controlled that, of the laser pulse train of a scan having the properties already described above, it emits only those laser spots having their impingement points within the lower projection surfaces 91.2 for a calibrated laser scanner 41 so that only the lower projection surfaces 91.2 are exposed.

By means of one of the test cameras 5, it can now be ascertained on the one hand whether or not the laser spots of the selected laser pulses lie completely within the lower projection surfaces 91.2. If the laser spots, viewed from the side, do not lie completely on the lower projection surfaces 91.2, the zero position of the scanning plane of the laser scanner 41 is not located in the reference zero position or not within a permissible tolerance limit around the reference zero position.

If the laser spots extends upward or downward beyond the lower projection surfaces 91.2, this indicates that the scanning plane has wandered out of the position of the reference scanning plane or out of the tolerance limit around the reference scanning plane.

A redundant check can be made by means of the obtained actual quality curve as to whether or not the laser spots all lie completely on the projection surfaces 91. If a laser spot partially extends beyond the edge of one of the projection surfaces 91, the quality of the receive signal lies below the expected reference quality. However, in order to conclude from this that the zero position has shifted, it must be ensured that the scanning plane extends at the correct height so that the cause of the deviations of the quality can be traced back to a shifting of the zero position.

The testing of the zero position by means of the evaluation of the actual quality curve can also be carried out by means of a scan with a complete laser pulse train.

The zero position can be recalibrated with knowledge of a deviation of the actual zero position from a reference zero position.

### Testing of Test Criterion 3—Conformality of the Scan in Degree and Equidistance

This test step proceeds in a manner analogous to the test step for the second test criterion. If the laser spots, as seen from the side, do not lie completely on the lower projection surfaces 91.2, the scanning angle γ of the laser pulses causing the laser spots in question deviates from the reference scanning angle φ.

A redundant check can be made by means of the obtained actual quality curve as to whether or not the laser spots all lie completely on the projection surfaces 91. If a laser spot partially extends beyond the edge of one of the projection surfaces 91, the quality of the receive signal lies below the expected reference quality.

### Testing of Test Criterion 4—Beam Characteristics, Particularly Divergence of the Laser Beam

Different parameters of the laser beam must be measured in order to check the characteristics of the laser beam. The middle lower projection surface 91.2 is used for this purpose. For a plurality of consecutive scans, only one laser pulse of a pulse train with the characteristics described above is initiated, namely, the laser pulse impinging centrally on the middle projection surface of the lower projection surfaces 91.2. By means of the test camera 5, an image is recorded over the duration of a minimum quantity of scans sufficient for the exposure so that the images of the laser spots overlap in the image. Suitable parameters for the description, e.g., the brightness of the laser spots, the actual laser spot width and the actual laser spot height or possibly also the quantity and intensity distribution of individual stacks of a laser diode emitting the laser beam, can then be obtained from this image so that the laser beam, can be parameterized with sufficient accuracy.

### Testing of Test Criterion 5—Exactness of the Distance Measurement

For a redundant testing of the accuracy of the distance measurement, a plurality of measuring distances of different optical path lengths are realized in the testing apparatus.

A first measuring distance with a first optical path length is given by twice the distance to the measuring board 8 which is determined by averaging from the distance between the laser scanner 41 and measuring board 8 and can be, e.g., 3 m. The distance changes over the scanning angle region within known limits which are taken into account in the test.

Two further optical path lengths are given by a juxtaposition of the arrangement of one or two of the individual mirrors 7 and one or two of the mirror surfaces 11 of the measuring board 8. Assuming a distance of 3 m by way of example, a second measuring distance of 6 m and a third measuring distance of 9 m are integrated in the testing apparatus. Depending on the size of the mirror surface 11 and individual mirrors 7, these measuring distances can be impinged upon by an individual laser spot or a plurality of laser spots. The length of the measuring distances is measured by measuring the time-of-flight of the laser pulse and is compared with the optical path lengths for the measuring distances which are known from the setup of the testing apparatus and have been stored. The measuring distances are toleranced in such a way that the measurement deviation for the distance measurement of the laser scanner 41 supplies a reliable indication of the quality of the distance measurement.

### Testing of Test Criterion 6—Transmitting Power of the Laser Diode of the Laser Scanner 41

In order to test the transmitting power of the laser diode, an attenuation disk 12 is inserted between the measuring board 8 and the laser scanner 41. The attenuation disk 12 serves for adjusting the pulse output of the laser diode to the conditions in the testing apparatus with the small measuring distance of, e.g., 3 m to 9 m. It is so dimensioned that a laser pulse impinging on the black surface of the measuring board 8 is reflected in such a way that a receive signal from which a reliable distance value can be formed can just be detected. With knowledge of the absorption of the attenuation disk 12, the transmitting power of the laser diode of the laser scanner 41 can be deduced from the quality of the measured values.

### Testing of Test Criterion 7—Timing Accuracy and Synchronous Running of the Polygon Mirror

The measurement of timing accuracy of the sequence control in the laser scanner 41 and the synchronous running of the polygon mirror in the laser scanner 41 is carried out in a manner analogous to the testing of the beam characteristics of the laser beam. For this purpose, an identical laser pulse of the laser sequences is activated over a plurality of scans and the location of impingement is recorded over the duration of the scans with a long exposure. The occurring image is then analyzed for sharpness criteria. Under ideal conditions of the laser scanner 41, there is a clear, sharply outlined image of the exactly overlapping laser spots in the image. If there is jitter in the sequences, the spot is not always deflected to the same location on the measuring board 8 and the image is blurry. The image can be evaluated by appropriate algorithms (e.g., such as are used for autofocusing).

### Testing of Test Criterion 8—Testing of Different Reflection Characteristics

As was stated in the description of the measuring board 8, this measuring board 8 comprises surfaces of different reflectivity which move between extremes, namely, the black surface of the measuring board 8, the projection surfaces 91 and the reflection surfaces 92. Using these surfaces of different reflectivity, the influence of the material and/or surface on the distance measurement can be evaluated.

Testing of Test Criterion 9—Alignment of Camera 42 with Respect to the Laser Scanner 41

After testing the position of the scanning plane with respect to the scanner-specific coordinate system of the laser scanner 41, the alignment of the camera 42 relative to this scanner-specific coordinate system must also be aligned.

The laser scanner 41 and the camera 42 have already been adjusted with respect to one another at the factory by a fixed screw connection so that the camera 42 is basically aligned with the scanner-specific coordinate system.

The white frame 13 surrounding the measuring board 8 and the pattern defined by the arrangement and geometry of the components of the measuring board 8, particularly the line pattern, are used for testing. The alignment of the camera 42 relative to this frame 13 can be deduced from the recording of the frame 13 and knowledge of the actual geometry and alignment of the frame 13. Since the laser scanner 41 is already aligned relative to the measuring board 8, the alignment of the camera 42 in the laser scanner coordinate system can accordingly be determined.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

### LIST OF REFERENCE NUMERALS

1 base plate
2 adjusting plate
3 receiving place
4 traffic monitoring device/TMD
41 laser scanner
42 camera
5 test camera
6 test laser
7 individual mirror
8 measuring board
9 measuring surface
91 projection surface
91.1 upper projection surface
91.2 lower projection surface
92 reflection surface
92.1 vertical line
92.1.1 narrow vertical line
92.1.2 wide vertical line
92.2 diagonal line
10 storage
11 mirror surface
12 attenuation disk
13 frame
14 measuring mark
15 illumination device
16 deflecting mirror
M center line
Φ scanning angle
A amplitude
L longitudinal axis of the coordinate system associated with the base plate
Q transverse axis of the coordinate system associated with the base plate
L′ longitudinal axis of the coordinate system associated with the scanner
Q′ transverse axis of the coordinate system associated with the scanner
S_{L} reference laser spot length
S_{B} reference laser spot width
D_{L} length of the diagonal line
α angle
G imaginary straight line

What is claimed is:

1. Testing apparatus for a traffic monitoring device with a laser scanner, comprising an adjusting plate having a receiving place for receiving a traffic monitoring device which is to be tested, and a measuring board which is arranged at a fixed distance from the adjusting plate and which has a line pattern along an imaginary straight line with a plurality of vertical lines running perpendicular to the straight line and with a diagonal line, wherein the adjusting plate and the measuring board can be aligned relative to one another in such a way that the straight line lies in a reference scanning plane of the laser scanner, and the diagonal line intersects the straight line on a perpendicular center line of the measuring board, wherein said diagonal line forms an angle with the straight line, said angle being selected in such a way that laser pulses emitted by the laser scanner form at least three laser spots with a reference laser spot width and a reference laser spot length on said diagonal line.

2. Testing apparatus according to claim 1, wherein said angle=arc sign (S_{L}/2)/(D_{L}/2), where S_{L} is the reference laser spot length and D_{L} is the length of the diagonal line, so that a maximum quantity of laser spots impinge on the diagonal line.

3. Testing apparatus according to claim 1, wherein the vertical lines are narrow vertical lines with a line width equal to the reference laser spot width and/or wide vertical lines with a line width equal to a multiple of the reference laser spot width, and the line length of the vertical lines is equal to the reference laser spot length so that a deviation of the scanning plane from the reference scanning plane and a deviation of a zero position of the scanning plane from a reference zero position can be determined.

4. Testing apparatus according to claim 1, further comprising an attenuation disk provided between the adjusting plate and the measuring board, and wherein the measuring board has a matte black surface with a reflectivity which, in cooperation with the attenuation disk, ensures that a reflection of the laser pulses of a laser beam coming from the laser scanner back into the laser scanner is sufficient to form a distance value from the generated receive signal.

5. Testing apparatus according to claim 1, wherein the measuring board has a rectangular shape, and wherein a measuring mark is provided in a center at each of the four edges, and further comprising a test laser mounted on the adjusting plate so as to be aligned therewith, said test laser being suitable for emitting a test laser beam with a cross-shaped beam cross section by which the measuring board and adjusting plate can be aligned relative to one another.

6. Testing apparatus according to claim 1, wherein the measuring board has lower projection surfaces at the level of the line pattern, and a test camera is associated with the testing apparatus, said test camera being mounted on the adjusting plate so as to be aligned therewith such that the lower projection surfaces lie in an object plane of the test camera so that laser spots imaged on the lower test surfaces are recorded by the test camera for evaluation.

7. Testing apparatus according to claim 1, further comprising two upper projection surfaces carried by said measuring board above the line pattern, and two deflecting mirrors and a test camera are associated with the testing apparatus, wherein the test camera is mounted on the adjusting plate so as to be aligned therewith such that the upper projection surfaces lie in an object plane of the test camera, and the two deflecting mirrors are so arranged that impinging laser pulses impinge on one of the upper projection surfaces in each instance.

8. Testing apparatus according to claim 1, wherein the measuring board has at least one mirror surface, and at least one individual mirror is associated with the testing apparatus, and the at least one mirror surface and the at least one individual mirror are arranged with respect to one another and with respect to the adjusting plate such that a laser pulse impinges on the measuring board so as to be repeatedly folded to realize at least one measuring distance corresponding to a multiple of the distance between the adjusting plate and measuring board.

9. Testing apparatus according to claim 1, wherein the measuring board has a surrounding white frame which is used for aligning a camera that is possibly associated with the device, and the testing apparatus has an illumination device for illuminating the measuring board.

10. Testing method for a traffic monitoring device with a laser scanner, characterized in that a scanner-specific coordinate system of a traffic monitoring device and a measuring board with a line pattern along an imaginary straight line with a plurality of vertical lines running perpendicular to the straight line and a diagonal line which intersects the straight line on a perpendicular center line of the measuring board, wherein it forms an angle with the straight line, which angle is selected in such a way that at least three laser spots of laser pulses emitted by the laser scanner, which three laser spots have a reference laser spot width and a reference laser spot length, impinge on the diagonal line, are so aligned with respect to one another that the straight line lies in a reference scanning plane of the laser scanner, in that the laser scanner emits a laser beam with a plurality of laser pulses over a scanning angle region, which laser pulses impinge on the measuring board, where each of them forms one of the laser spots, and when impinging on the perpendicularly extending vertical lines and the diagonal line, the laser pulses are reflected in a receiver of the laser scanner, where there are generated receive signals having an amplitude, in that an actual quality curve of the amplitude over the scanning angle is formed from the values of the amplitude of the receive signals and is compared with a known reference quality curve in order to deduce the position of the actual scanning plane compared to the reference scanning plane.
